(19) United States
(12) Patent Application Publication
(10) Pub. No.: US 2022/0223928 A1
(43) Pub. Date: Jul. 14, 2022

(54) FUNCTIONAL COATING FOR SEPARATOR

(71) Applicant: Celgard, LLC, Charlotte, NC (US)

(72) Inventors: Insik Jeon, lthaca, NY (US); James Rapley, Concord, NC (US); Fru Azeh, Charlotte, NC (US)

(21) Appl. No.: 17/613,104

(22) PCT Filed: May 22, 2020
(86) PCT No.: PCT/US2020/034116

§ 371 Date: Nov. 22, 2021

Related U.S. Application Data
(60) Provisional application No. 62/852,366, filed on May 24, 2019.

(51) Int. Cl. H01M 10/42; H01M 50/446; H01M 50/491; H01M 50/451

(52) U.S. Cl. CPC H01M 10/4235; H01M 50/446; H01M 10/0525; H01M 50/451; H01M 2200/10; H01M 50/491

(57) ABSTRACT

A coated separator including a microporous film and a coating on at least one side of the microporous film, wherein the coated separator shuts down at a temperature less than or equal to 140° C. In some embodiments, the coating causes the separator to shutdown at a temperature lower than the temperature at which the microporous film would shrink more than 15%, more than 12%, more than 10%, or preferably more than 5% without any coating. The microporous film of the separator by itself (uncoated) does not shut down or does not shutdown at a temperature less than or equal to 140° C. The microporous film may shut down at a temperature between 140° C. and 350° C. The coating of the coated separator may contain polyethylene, binder, and inorganic or heat resistant fine particles. Fine particles may have a particle size D50 less than or equal to 500 nm.

### CROSS-REFERENCE TO RELATED APPLICATIONS

The present application is a 371 U.S. Application of PCT/US2020/034116, filed May 22, 2020, which claims priority to and the benefit of U.S. provisional patent application Ser. No. 62/852,366, filed May 24, 2019, which hereby fully incorporated by reference herein

### FIELD

This application is directed to novel or improved battery separators or membranes having, among other things, improved safety, one or more coatings, various functional coatings, and/or the like.

### BACKGROUND

Increasing performance standards, safety standards, manufacturing demands, and/or environmental concerns make development of new and/or improved coating compositions for battery separators desirable.

One major safety issue for lithium-ion batteries is thermal runaway. Abuse conditions, such as overcharge, over-discharge, and internal short-circuits, for example, can lead to battery temperatures far above those which the temperatures that battery manufacturers intended their batteries to be used. Tests for simulating abuse conditions may include, but are not limited to nail penetration tests and hot-box tests. Shutdown of the battery, e.g., a stopping of ionic flow across the separator, e.g., between an anode and a cathode in the event of thermal runaway, is a safety mechanism used to prevent thermal runaway. Separators in at least certain lithium-ion batteries must offer the ability to shutdown at temperatures at least slightly lower than that at which thermal runaway occurs, while still retaining their mechanical properties. Faster shutdown at lower temperatures and for a longer duration, e.g., so that the user or device has longer time to turn off the system, is very desirable. In some embodiments, shutdown may occur by filling and/or closing of the separator pores with melted polymer.

Nail penetration testing is a type of battery safety testing done to simulate internal short circuiting (e.g., due to lithium dendrite growth in a lithium ion battery). Typically, a sample battery is prepared containing an anode, a cathode, and a separator between the anode and the cathode. The sample battery is penetrated with a nail to simulate internal short circuit, and to verify that the battery does not catch fire or burst. Various nail penetration speeds are used in the industry. One way to prevent the sample battery from catching fire or bursting (possible results of thermal runaway) is to use a battery separator that shuts down. Typically, most battery separators can shut down, but some shutdown at higher temperatures than others. However, even some battery separators that shutdown, may fail all or some nail penetration tests (e.g., tests using some nail speeds, but not others). Thus, a battery separator that passes all or many industry nail penetration tests is desired or valuable.

### SUMMARY

The coated separators or membranes described herein may include a microporous film with a coating and provides shutdown at low temperature despite the ability of the microporous film to shut down or to shut down at low temperatures.

It is theorized by the inventors of this application that dimensional change (e.g., shrinking) of the separator at increasing temperatures may be one reason that separators fail the nail penetration test. If the battery separator does not shutdown before shrinkage exceeds a threshold amount, this may lead to failure of a nail penetration test. Typically, batteries are designed so that the separator covers the electrodes as shown in FIG. 1. However, if shrinkage exceeds a threshold amount, the electrodes may be exposed (See FIG. 2) leading to a thermal runaway situation that may lead to fire or bursting if this occurs before the separator can shutdown.

To solve this problem, the inventors of this application propose a separator that shuts down before dimensional change (e.g., shrinkage) exceeds a threshold amount.

In one aspect, the separator is a coated separator including a microporous film and a coating. The coated separator shuts down at a temperature less than 140° C. In some embodiments, the coated separator shuts down at a temperature less than 135° C., less than 130° C., less than 125° C., less than 120° C., less than 115° C., less than 110° C., less than 105° C., or less than 100° C.

In some preferred embodiments, the microporous film itself (uncoated) does not shutdown at a temperature less than 140° C. The microporous film, in some embodiments, does not shut down or shuts down at a temperature between 140° C. and 350° C. In some embodiments, the microporous film itself (uncoated) does not shutdown at a temperature less than 135° C. In some embodiments it does not shutdown or shuts down at a temperature between 135° C. and 350° C. In some embodiments, the microporous film does not shut down or shuts down at a temperature between 160° C. and 350° C. In some embodiments, it does not shut down or shuts down at a temperature between 135° C. and 160° C.

In some embodiments, the microporous film comprises, consists of, or consists essentially of a polyolefin. In some embodiments, the polyolefin is polypropylene or another polyolefin that has a melt temperature at or above 160° C. In some embodiments, the microporous film is a monolayer film made of polypropylene or another polyolefin having a melt temperature at or above 160° C.

The microporous film may be a monolayer, bilayer, trilayer, or multilayer film. In some embodiments, the microporous film may be a monolayer film that comprises, consists of, or consists essentially of polypropylene. The microporous film may be a film having an average porosity greater than 30% in some embodiments. In some embodiments, the microporous film may be a film having pores with an average pore size being greater than 0.03 microns, greater than 0.04 microns, or greater than 0.045 microns.

The coating described herein may be one that comprises, consists of, or consists essentially of polyethylene and a binder. In some embodiments, the coating may further comprise, consist of, or consist essentially of inorganic fine particles in an amount of 10% or less or 5% or less of the total solids in the coating.

In some embodiments, the inorganic fine particles may comprise a metal oxide having a particle size D50 of about 500 nm or less, 250 nm or less or 200 nm or less. In some embodiments, the metal oxide may comprise, consist of, or consist essentially of alumina.

In one aspect, the separator is a coated separator comprising a microporous film and a coating is described. The microporous film itself may be used as a battery separator, but by coating the microporous film to form the separator, the separator shuts down at a temperature lower than the temperature at which the microporous film would shrink more than 15% without any coating. The coating may be applied to one or both sides of the microporous film.

In some embodiments, the coating causes the separator to shutdown at a temperature lower than the temperature at which the microporous film would shrink more than 12% without any coating. In some embodiments, the coating causes the separator to shutdown at a temperature lower than the temperature at which the microporous film would shrink more than 10% without any coating. In some embodiments, the coating causes the separator to shutdown at a temperature lower than the temperature at which the microporous film would shrink more than 5% without any coating.

In some embodiments, the coated separator described herein shuts down at a temperature less than 140° C., less than 135° C., less than 130° C., less than 125° C., less than 120° C., less than 115° C., less than 110° C., or less than 100° C. In all cases, the shutdown temperature of the separator is lower than the shutdown temperature of the microporous film itself, i.e., without any coating.

In some preferred embodiments, the microporous film itself (uncoated) does not shutdown at a temperature less than 140° C. The microporous film, in some embodiments, does not shut down or shuts down at a temperature between 140° C. and 350° C. In some embodiments, the microporous film itself (uncoated) does not shutdown at a temperature less than 135° C. In some embodiments it does not shutdown or shuts down at a temperature between 135° C. and 350° C. In some embodiments, the microporous film does not shut down or shuts down at a temperature between 160° C. and 350° C. In some embodiments, it does not shut down or shuts down at a temperature between 135° C. and 160° C.

In some embodiments, the microporous film comprises, consists of, or consists essentially of a polyolefin. In some embodiments, the polyolefin is polypropylene or another polyolefin that has a melt temperature at or above 160° C. In some embodiments, the microporous film is a monolayer film made of polypropylene or another polyolefin having a melt temperature at or above 160° C.

The microporous film may be a monolayer, bilayer, trilayer, or multilayer film. In some embodiments, the microporous film may be a monolayer film that comprises, consists of, or consists essentially of polypropylene. The microporous film may be a film having an average porosity greater than 30% in some embodiments. In some embodiments, the microporous film may be a film having pores with an average pore size being greater than 0.03 microns, greater than 0.04 microns, or greater than 0.045 microns.

In some embodiments, the coating may comprise, consist of, or consist essentially of polyethylene and a binder. In some embodiments, the coating may further comprise, consist of, or consist essentially of inorganic fine particles in an amount of 10% or less of the total coating solids or in an amount of 5% or less of the total coating solids.

In some embodiments, the inorganic fine particles have a particle size D50 less than or equal to 500 nm, less than or equal to 250 nm or less than or equal to 200 nm. In some embodiments, the inorganic fine particles comprise, consist of, or consist essentially of a metal oxide having a particle size of less than or equal to 250 nm or less than or equal to 200 nm. In some embodiments, the metal oxide is alumina.

In another aspect, a secondary battery comprising a coated separator according to any embodiments as described herein is described. The battery may comprise at least electrode, a separator, and an electrolyte.

In another aspect, a capacitor comprising the battery separator according to any of the embodiments described herein is described.

### DESCRIPTION OF THE DRAWINGS

FIGS. 1 and FIG. 2 include a schematic drawing showing the effect of dimensional change (e.g., shrinkage) of the separator in a battery. Even though a battery separator may cover the electrodes when the cell is assembled (FIG. 1), it may subsequently shrink to expose the electrodes (FIG. 2).

FIG. 3 shows a typical shutdown profile.

FIG. 4 includes schematic drawings of one-side and two-side coated battery separators.

FIG. 5 includes a drawing of a typical structure for a dry-process porous membrane.

FIG. 6A and FIG. 6B are SEMs showing the typical structure fro dry-process porous membranes.

FIG. 7 is a schematic drawing illustrating the concept of tortuosity.

FIG. 8 shows a schematic view of a coating described herein.

FIG. 9 includes shutdown profiles for embodiments described herein.

FIG. 10 is a schematic drawing showing the affect of smaller and larger inorganic particles on packing.

FIG. 11 shows the curl of embodiments described herein.

FIG. 12 shows comparison of the properties of uncoated trilayer product and the trilayer product with a 95° C. shutdown coating.

FIG. 13 shows a shutdown shift after coating for some embodiments described herein.

FIG. 14 is a graph showing that the shutdown coatings described herein reduce pin removal force.

FIG. 15 is a schematic drawing showing a good result for a pin removal test.

FIG. 16 is a graph showing MD shrinkage and Gurley at 115° C., 120° C., 125° C., and 130° C.

FIG. 17 includes photographs of films according to some embodiments described herein.

FIG. 18 is a graph showing shutdown behavior for a coating with standard alumina vs. nano-alumina.

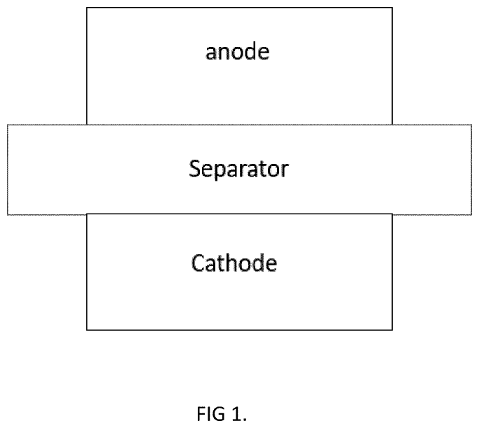

### DETAILED DESCRIPTION

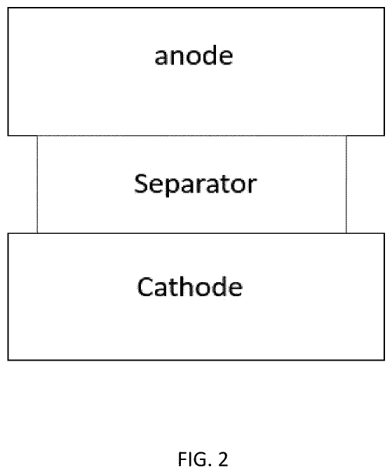

The preferred coated battery separator described herein is one that shuts down at a temperatures of 140° C. or less, 135° C. or less, 130° C. or less, 125° C. or les, 120° C. or less, 115° C. or less, 110° C. or less, 105° C. or less, or 100° C. or less. In some embodiments, the coated separator described herein shuts down before experiencing a threshold amount of dimensional change (e.g., shrinkage). Dimensional change above the threshold amount, may lead to a situation, when the separator is used in a battery, where electrodes are exposed to one another (i.e., there is no separator present between the electrodes as shown in FIG. 2) leading to a thermal runaway situation that may lead to shorting, failure, fire, or bursting if this occurs before the separator can shutdown.

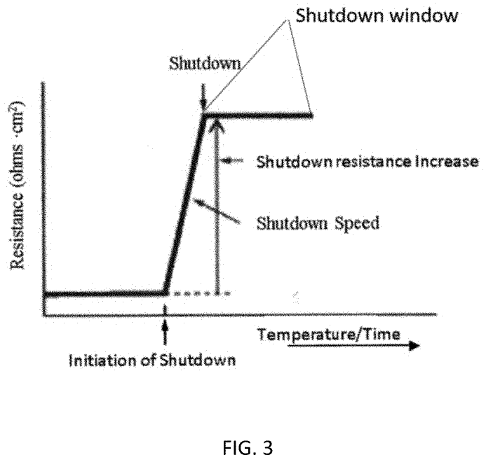

A typical shutdown profile is shown in FIG. 3. Shut down is indicated on the profile as “shutdown,” not initiation of “shutdown.” When the temperature of shutdown is referred to, it is the temperature indicated by “shutdown,” not “initiation of shutdown.”

For purposes of this application, shutdown occurs when the resistance level across the separator reaches 1,000 ohms or greater and lasts or remains above that value for at least 5° C. In some embodiments, shutdown may be occurring when the resistance across the separator may be 2,000 ohms or greater, 4,000 ohms or greater, 5,000 ohms or greater, 6,000 ohms or greater, 7,000 ohms or greater, 8,000 ohms or greater, 9,000 ohms or greater, or 10,000 ohms or greater and stays above that level for a period of at least 5° C. Sometimes the period may be a period of at least 10° C., at least 15° C., at least 20° C., at least 30° C., at least 40° C., or at least 50° C. In some embodiments, the period is from the initiation of shutdown to the end of the shutdown window. Sometimes it is the shutdown window.

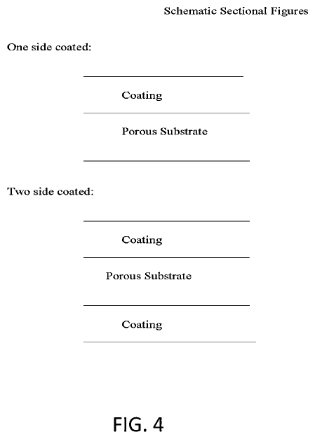

The battery separator described herein is not so limited and may be coated or uncoated. In preferred embodiments, the battery separator is a coated battery separator comprising a coating on at least one side of a microporous film. In some embodiments, the coating may be applied to both sides of the microporous film. Exemplary one-side and two-side coated battery separators are shown in FIG. 4. In some embodiments, the coating described herein may be on one side of a microporous film in a two-side coated separator, and the other side of the microporous film may have a different coating. For example, it may have a ceramic coating. In some embodiments, the coating described herein may be on both sides of the microporous film.

In some embodiments, the coated separator described herein shuts down at a temperature less than 140° C., less than 135° C., less than 130° C., less than 125° C., less than 120° C., less than 115° C., less than 110° C., or less than 100° C. In the preferred cases, the shutdown temperature of the coated separator is lower than the shutdown temperature of the microporous film itself, i.e., without any coating.

Coating

The coating described herein is not so limited, and any coating may be used that is not inconsistent with the stated goals herein (and does not harm the battery). In some preferred embodiments, the coating causes the separator to shut down at a lower temperature than the microporous film itself shuts down. Sometimes the coating causes the separator to shut down at a temperature less than 140° C., less than 130° C., less than 120° C., less than 110° C., or less than 100° C. where the microporous film itself either does not shutdown or shuts down at a higher temperature.

In some preferred embodiments, the coating causes the separator to shutdown at a temperature lower than the temperature at which the microporous film would shrink more 15%, more than 12%, more than 10, or more than 5% without any coating. In some embodiments, the coating causes the separator to shutdown at a temperature lower than the temperature at which the microporous film would shrink more than 20%, more than 15%, more than 14%, more than13%, more than 11%, more than 10%, more than 9%, more than 8%, more than 7%, more than 6%, more than 5%, more than 4%, more than 3%, more than 2%, or more than 1% without any coating.

In some embodiments, the coating may comprise, consist of, or consist essentially of polyethylene and a binder. In some embodiments, the coating may further comprise, consist of, or consist essentially of inorganic fine particles. The amount of inorganic fine particles in the coating may not exceed 10% of the total solids in the coating. In some embodiments, they may not exceed 9%, 8%, 7%, 6%, 5%, 4%, 3%, 2%, or 1% of the total solids in the coating.

In some preferred embodiments, the coating may be an aqueous or water-based coating. “Water-based” means that the coating was formed from a slurry where the solvent is water or water and a small amount, less than 5%, of another solvent such as an alcohol. The coating may also be a solvent-based coating, which is a coating formed from a slurry where the solvent is an organic solvent. Solvent-based and water-based coatings are structurally different. In some embodiments, a water-based coating may be preferred due to the high uniformity of such a coating.

Polyethylene

The polyethylene used in the coating is not so limited. Any polyethylene not inconsistent with the stated goals herein may be used. In some preferred embodiments, lower molecular weight (and thus lower melting point) polyethylene may be used. In some embodiments, lower molecular weight polyolefins may be used. In some embodiments, the polyolefins, including polyethylenes, may have a melting temperature between 90° C. and 140° C., between 100° C. and 140° C., between 110° C. and 140° C., between 120° C. and 140° C., or between 130° C. and 140° C. In some embodiments, the particle size of the polyethylenes or polyolefins may be between 0.5 to 5 microns, between 0.5 and 4 microns, between 0.5 and 3 microns, between 0.5 and 2 microns, or between 0.5 and 1 microns. A coating comprising polyethylene particles or beads may be preferred.

Binder

The binder used in the coating is not so limited. Any binder not inconsistent with the stated goals herein may be used.

In some embodiments, the binder may be an acrylic. In some embodiments, the binder may be a polymeric binder comprising, consisting of, or consisting essentially of a polymeric, oligomeric, or elastomeric material and the same are not limited. Any polymeric, oligomeric, or elastomeric material not inconsistent with this disclosure may be used. The binder may be ionically conductive, semi-conductive, or non-conductive. Any gel-forming polymer suggested for use in lithium polymer batteries or in solid electrolyte batteries may be used. For example, the polymeric binder may comprise at least one, or two, or three, etc. selected from a polylactam polymer, polyvinyl alcohol (PVA), Polyacrylic acid (PAA), Polyvinyl acetate (PVAc), carboxymethyl cellulose (CMC), an isobutylene polymer, an acrylic resin, latex, an aramid, or any combination of these materials.

In some preferred embodiments, the polymeric binder comprises, consists of, or consists essentially of a polylactam polymer, which is a homopolymer, co-polymer, block polymer, or block co-polymer derived from a lactam. In some embodiments, the polymeric material comprises a homopolymer, co-polymer, block polymer, or block co-polymer according to formula (1).

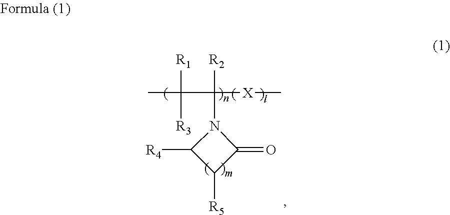

wherein R₁, R₂, R₃, and R₄ can be alkyl or aromatic substituents and R₅ can be an alkyl substituent, an aryl substituent, or a substituent comprising a fused ring; and wherein the preferred polylactam can be a homopolymer or a co-polymer where co-polymeric group X can be derived from a vinyl, a substituted or un-substituted alkyl vinyl, a vinyl alcohol, vinyl acetate, an acrylic acid, an alkyl acrylate, an acrylonitrile, a maleic anhydride, a maleic imide, a styrene, a polyvinylpyrrolidone (PVP), a polyvinylvalerolactam, a polyvinylcaprolactam (PVCap), polyamide, or a polyimide; wherein m can be an integer between 1 and 10, preferably between 2 and 4, and wherein the ratio of 1 ton is such that 0≤1:n≤10 or 0≤1:n≤1. In some preferred embodiments, the homopolymer, co-polymer, block polymer, or block co-polymer derived from a lactam is at least one, at least two, or at least three, selected from the group consisting of polyvinylpyrrolidone (PVP), polyvinylcaprolactam (PVCap), and polyvinyl-valerolactam.

In another preferred embodiment, the polymeric binder comprises, consists of, or consists essentially of polyvinyl alcohol (PVA). Use of PVA may result in a low curl coating layer, which helps the substrate to which is it applied stay stable and flat, e.g., helps prevent the substrate from curling. PVA may be added in combination with any other polymeric, oligomeric, or elastomeric material described herein, particularly if low curling is desired.

In another preferred embodiment, the polymeric binder may comprise, consist of, or consists essentially of an acrylic resin. The type of acrylic resin is not particularly limited, and may be any acrylic resin that would not be contrary to the goals stated herein, e.g., providing a new and improved coating composition that may, for example, be used to make battery separators having improved safety. For example, the acrylic resin may be at least one, or two, or three, or four selected from the group consisting of polyacrylic acid (PAA), polymethylmethacrylate (PMMA), polyacrylonitrile (PAN), polymethyl acrylate (PMA).

In other preferred embodiments, the polymeric binder may comprise, consist of, or consist essentially of carboxymethyl cellulose (CMC), an isobutylene polymer, latex, or any combination these. These may be added alone or together with any other suitable oligomeric, polymeric, or elastomeric material.

In some embodiments, the polymeric binder may comprise a solvent that is water only, an aqueous or water-based solvent, and/or a non-aqueous solvent. When the solvent is water, in some embodiments, no other solvent is present. The aqueous or water-based solvent may comprise a majority (more than 50%) water, more than 60% water, more than 70% water, more than 80% water, more than 90% water, more than 95% water, or more than 99%, but less than 100% water. The aqueous or water-based solvent may comprise, in addition to water, a polar or non-polar organic solvent. The non-aqueous solvent is not limited and may be any polar or non-polar organic solvent compatible with the goals expressed in this application. In some embodiments, the polymeric binder comprises only trace amounts of solvent, and in other embodiments it comprises 50% or more solvent, sometimes 60% or more, sometimes 70% or more, sometimes 80% or more, etc.

The amount of binder, in some preferred embodiments, may be less than 20%, less than 15%, less than 10%, or less than 5% of the total solids in the coating. In some particularly preferred embodiments, the amount of binder may be 10% or less, or 5% or less of the total solids in the coating.

Inorganic Fine Particles

Inorganic fine particles are not so limited. Any inorganic fine particles that are not inconsistent with the stated goals herein may be used. The inorganic fine particles may have a particle size D50 less than 500 nm, less than 450 nm, less than 400 nm, less than 350 nm, less than 300 nm, less than 250 nm, less than 225 nm, less than 200 nm, less than 175 nm, less than 150 nm, less than 125 nm, less than 100nm, less than 75 nm, or less than 50 nm. Without wishing to be bound by any particular theory, it is believed that the use of larger particles may inhibit shutdown by blocking the flow of polymer, e.g., polyethylene, from the coating and into the pores of the separator. Use of high amounts of inorganic particles of any size may also block flow of polymer into the pores of the separator to block ionic flow.

In some embodiments, the inorganic fine particles may comprise, consist of, or consist essentially of one or more metal oxides. In some embodiments the metal oxide may be (or one of the metal oxides may be) alumina.

In some embodiments, inorganic fine particles may be at least one selected from the group consisting of: iron oxides, silicon dioxide (SiO₂), aluminum oxide (Al₂O₃), boehmite (Al(O)OH), zirconium dioxide (ZrO₂), titanium dioxide (TiO₂), barium titanium oxide (BaTiO₃), tin dioxide (SnO₂), indium tin oxide, oxides of transition metals, graphite, carbon, metal, and any combinations thereof.

In preferred embodiments, the ratio of the size of the inorganic fine particles to the size of the polymer particles is 0.5:1 or less. In some preferred embodiments, the ratio is 0.4:1 or less. 0.3:1 or less, 0.2:1 or less, 0.1:1 or less, or 0.05:1 or less. In some embodiments, the polymer particles are as much as 2 times, 3 times, 5 times, 10 times, 12 times, 15 times, or 20 times the size of the inorganic fine particles.

Microporous Film

The microporous film is not so limited, and any microporous film not contrary to the stated goals herein may be used. In some preferred embodiments, the microporous film may be one as described in Celgard® U.S. Pat. No. 8,795,565 entitled “Biaxially Oriented Microporous Membrane.”

The microporous film may be a monolayer, bilayer, trilayer, or multilayer film. In some preferred embodiments, the microporous film may be a monolayer, bilayer, trilayer, or multilayer film made by a dry process, including the Celgard® dry-stretch process, or wet process known in the art.

In some embodiments, the microporous film may comprise, consist of, or consist essentially of a polyolefin. In some embodiments, the microporous film is a monolayer film comprising, consisting of or consisting essentially of polypropylene or a polypropylene-polyethylene block co-polymer having between 1-10% polyethylene.

In preferred embodiments, the microporous film may have an average pore size between 0.1 and 1.0 microns. In some embodiments, the microporous film may have a porosity of 20% or more, 30% or more, 40% or more, 50% or more, or 60% or more, up to 80% or 90%. Without wishing to be bound by any particular theory, it is believed that films with higher porosity and/or bigger pores may have a more difficult time shutting down themselves, i.e., without any coating. This may be because when the polymer that the microporous film is made of melts there may not be enough to fully block or close the pores. Blockage of the pores is believed to be what stops ionic flow across the film.

A dry-process, in some embodiments, is a process that does not use any pore-forming agent/pore-former, or beta-nucleating agent/beta-nucleator. In some embodiments, a dry-process is one that does not use any solvent, wax, or oil. In some embodiments, a dry-process is one that does not use any pore-forming agent/pore former, or beta-nucleating agent/beta-nucleator, and also does not use any solvent, wax, or oil. In such embodiments, the dry process may be a dry-stretch process. An exemplary dry-stretch process known as the Celgard® dry stretch process is described in Chen et al., Structural Characterization of Celgard® Microporous Membrane Precursors: Melt-Extruded Polyethylene Films, J. of Applied Polymer Sci., vol. 53, 471-483 (1994), which is incorporated by reference herein in its entirety. The Celgard® dry stretch process refers to a process where pore formation results from stretching a nonporous oriented precursor at least in the machine direction. Kesting, Robert E., Synthetic Polymeric Membranes, A Structural Perspective, Second Edition, John Wiley & Sons, New York, N.Y., (1985), pages 290-297, also discloses a dry-stretch process and is incorporated herein by reference in its entirety. In a dry-stretch process according to some preferred embodiments, the process may comprise a stretching step. The stretching step may comprise, consist of, or consist essentially of uniaxial stretching (e.g., stretching in only the MD direction or in only the TD direction), biaxial stretching (e.g., stretching in the MD and TD direction), or multi-axial stretching (e.g., stretching along three or more different axes such as MD, TD, and another axis). In some embodiments, the dry-stretch process may comprise, consist of, or consist essentially of an extrusion step and a stretching step, in that order or not in that order. In some embodiments, the dry stretch process may comprise, consist of, or consist essentially of an extrusion step, an annealing step, and a stretching step, in that order or not in that order. The extrusion step, in some embodiments, may be a blown-film extrusion step or a cast-film extrusion process. In some embodiments, a non-porous precursor is extruded and stretched to form pores. In some embodiments, a non-porous precursor is extruded, annealed, and then stretched to form pores. In other embodiments, a porous or non-porous precursor may be formed by a method other than extrusion, such as by sintering or printing, and stretching may be performed on the precursor to form pores or to make existing pores larger.

In some embodiments, pore-forming agent/pore former, or beta-nucleating agent/beta-nucleator may be used and the process is still considered a dry-process. For example, a particle stretch process may be considered to be a dry process because oil or solvent is not extruded with the polymer and extracted from the extruded polymer to form pores. In a particle stretch process, particles such as silica or calcium carbonate are added to a polymer mixture, and these particles help to form the pores. In such a method, for example, the polymer mixture comprising particles and a polymer is extruded to form a precursor that is stretched and voids are created around the particles. In some embodiments, the particles may be removed after the voids are created. While a particle stretch process may include a stretching step before or after the removal of the particles, a particle stretch process is not considered a dry-stretch process because the principle pore formation mechanism is the use of the particles not stretching.

In some preferred embodiments, the structure of a dry-process porous membrane may have one or more distinguishing features. For example, a dry-process membrane may comprise an amount of polypropylene greater than 10%. Wet-processes or other processes using a solvent are not generally compatible with polypropylene because the solvents degrade polypropylene. Thus, wet process porous membranes typically contain no more than 10% polypropylene, and most typically 5% or less. One other distinguishing feature of some dry process porous membranes, particularly those used as battery separators, is the ability to have a shutdown function. Shutdown function may be imparted, in some cases, by a PP/PE/PP structure. This is unique to dry-process membranes because layers comprising mainly polypropylene (PP) generally cannot be formed in a wet process. A dry process is uniquely suited to form a PP/PE/PP shutdown membrane structure.

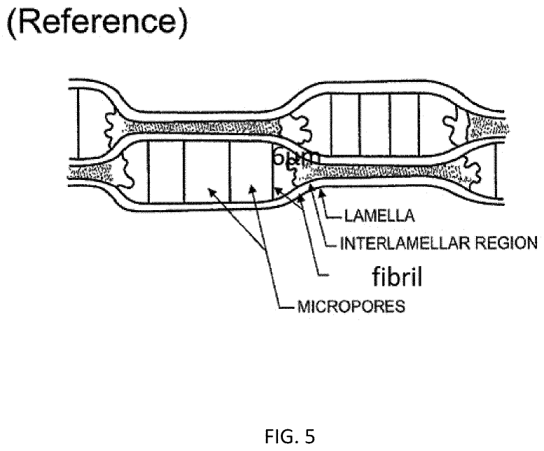

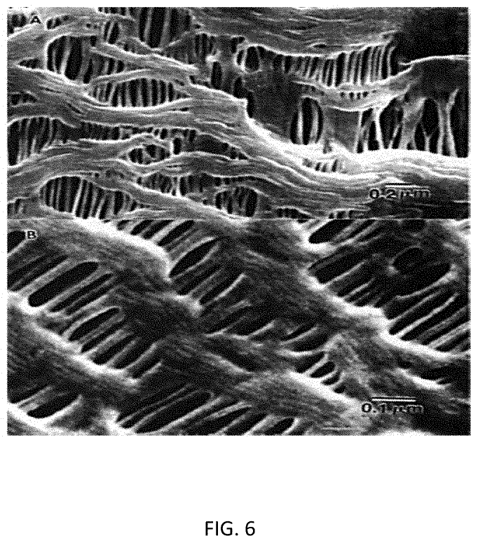

In some embodiments, a distinguishing dry-process porous membrane may be the presence of lamellae and fibrils. For example, the porous membrane may have a structure like that shown in FIG. 5 of FIGS. 6A and 6B. FIGS. 6A and 6B are FESM images showing slit-like micropores in Celgard® microporous membranes comprising PE (A) and PP(B). In some embodiments, the pores or micropores of a dry-process porous membrane may be round, oblong, semi-round, trapezoidal, etc.

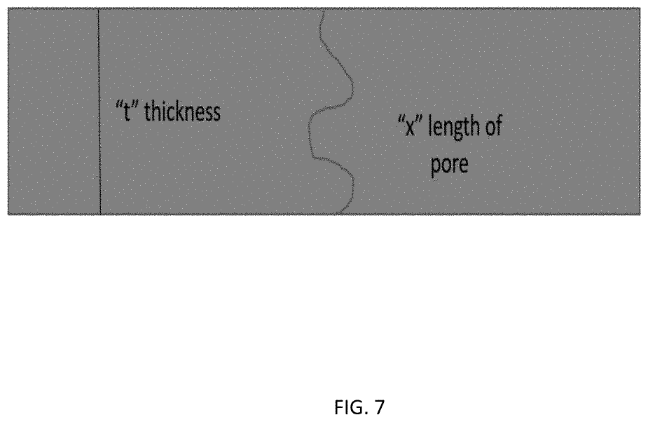

In some embodiments, a distinguishing feature of a dry-process porous membrane is that it contains no or substantially no pin-holes. Pin-holes are considered a defect, and generally are not an intentionally formed feature of a dry-process porous membrane. In some embodiments, the dry-process microporous membrane may contain no or substantially no pin-holes greater than 10 nm. In some preferred embodiments, the pores of a dry-process porous membrane are tortuous. In some embodiments, a distinguishing feature of a dry-process porous membrane is tortuosity. In some embodiments, the tortuosity of a dry-process porous membrane is greater than 1, greater than 1.2, greater than 1.3, greater than 1.4, greater than 1.5, greater than 1.6, greater than 1.7, greater than 1.8, greater than 1.9, or greater than 2.0. In some embodiments, a formula for calculating tortuosity crudely is formula (2):

$$Tortuosity = x / t \qquad ( 2 )$$

where “x” is the length of the opening or pore in a porous membrane and “t” is the thickness of the membrane. A pin-hole has a tortuosity of 1 because the length of the pin hole is the same as the thickness of the membrane. A tortuous pore has a tortuosity greater than 1 as shown in FIG. 7 because the length of the pore is longer than the thickness of the membrane.
In some embodiments, the dry-stretch porous membrane is semi-crystalline. In some embodiments, the dry-stretch porous membrane is semi-crystalline and oriented in a single direction. For example, the membrane may be MD-oriented. A porous film formed by a wet process, such as a film formed by a beta-nucleation process, may be randomly oriented.
In some embodiments, a coated separator including a microporous film and a coating on at least one side of the microporous film, wherein the coated separator shuts down at a temperature less than or equal to 140° C. In some embodiments, the coating causes the separator to shutdown at a temperature lower than the temperature at which the microporous film would shrink more than 15%, more than 12%, more than 10%, or preferably more than 5% without any coating. The microporous film of the separator by itself (uncoated) does not shut down or does not shutdown at a temperature less than or equal to 140° C. The microporous film may shut down at a temperature between 140° C. and 350° C. The coating of the coated separator may contain polyethylene, binder, and optional inorganic or heat resistant fine particles.

### EXAMPLES

### Example 1

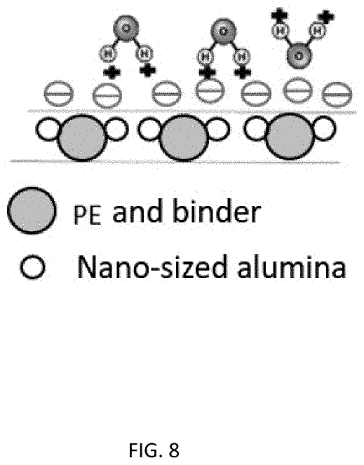

In Example 1, a coated separator was formed by coating a solution comprising polyethylene, nano-sized alumina, a binder, and water or a water-based solvent onto one side of a polypropylene monolayer microporous film. FIG. 8 shows a schematic view of the coating. The microporous film may be a biaxially oriented microporous membrane as disclosed in Celgard® patent No. U.S. Pat. No. 8,795,565.

### Example 2

In Example 2, a coated separator was formed by coating a solution comprising polyethylene, nano-sized alumina, a binder, and water or a water-based solvent onto both sides of a polypropylene monolayer microporous film. FIG. 8 shows a schematic view of the coating. The microporous film may be a biaxially oriented microporous membrane as disclosed in Celgard® patent No. U.S. Pat. No. 8,795,565.

FIG. 8 shows absorption of moisture at the surface of the coating, which improves the curl of the film. The nano-sized alumina absorbs moisture. Large surface area can attract a relatively large amount of moisture while small particle size should not affect the packing of PE. Use of larger sized inorganic particles can impact packing of PE and thus shutdown. In preferred embodiments, the ratio of the size of the inorganic particles to the size of the PE particles is 0.5:1 or less. In some preferred embodiments, the ratio is 0.4:1 or less. 0.3:1 or less, 0.2:1 or less, 0.1:1 or less, or 0.05:1 or less. In some embodiments, the PE particles are as much as 12 times, 15 times, or 20 times the size of the inorganic fine particles.

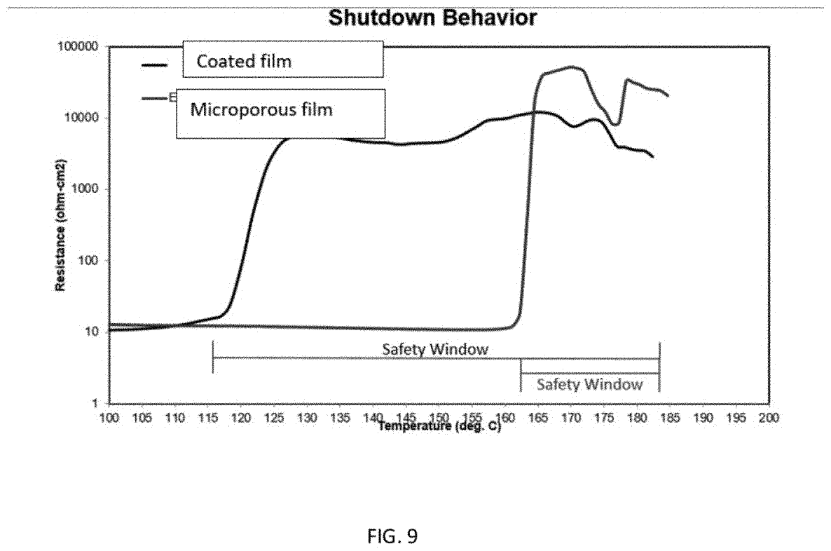

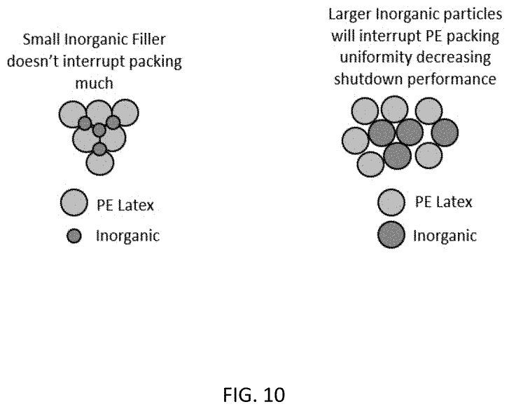

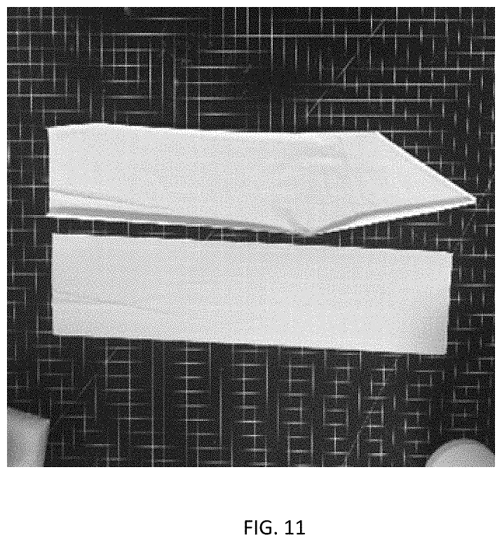

FIG. 9 shows the difference in shutdown temperature for an uncoated microporous film (blue) and a coated microporous film like the separator (black line) described herein. The microporous film used has a shrinkage of 15% at a temperature of between 120° C. to 125° C. Shrinkage is 13% at approximately 120° C., 19% at approximately 130° C., and at 160° C. shrinkage is greater than 50%.
Addition of alumina nanoparticles (inorganic nanoparticles) is shown to improve curl as shown in FIG. 11. The top sample has no added alumina, but the bottom sample does. Without wishing to be bound by any particular theory, it is believed that using alumina (inorganic particles) improves curl through moisture adsorption. The alumina, because of its small particle size and large surface area, can attract relatively large amount of moisture while small particle size shouldn't impact packing of PE so not big impact on shutdown compared to using larger alumina particles like in the past. Below, in FIG. 10, is demonstrated why smaller inorganic particles are preferred herein. By increasing the surface area (smaller particles) a relatively large amount of charge neutralizing water molecules are attracted, while at the same time, the smaller particles do not interrupt the packing uniformity like the larger particles do as shown in FIG. 10.

### Example 3

A water-based coating comprising polyethylene, a binder, and nano-sized alumina was provided on one side (Example 3A) and on two side (Example 3B) of a microporous film that is made from a polymer having a melting point above 200° C. The microporous film may be one that does not shutdown or that shuts down at a temperature above 200° C.

### Example 4

A water-based coating comprising polyethylene, a binder, and nano-sized alumina was provided on one side (Example 4A) and on two side (Example 4B) of a microporous film that is made from a polymer having a melting point above 250° C. The microporous film may be one that does not shutdown or that shuts down at a temperature above 250° C.

### Example 5

A water-based coating comprising polyethylene, a binder, and nano-sized alumina was provided on one side (Example 5A) and on two side (Example 5B) of a microporous film that is made from a polymer having a melting point above 300° C. The microporous film may be one that does not shutdown or that shuts down at a temperature above 300° C.

### Example 6

A water-based coating comprising polyethylene, a binder, and nano-sized alumina was provided on one side (Example 6A) and on two side (Example 6B) of a microporous film that is made from a polymer having a melting point above 180° C. The microporous film may be one that does not shutdown or that shuts down at a temperature above 180° C.

### Example 7

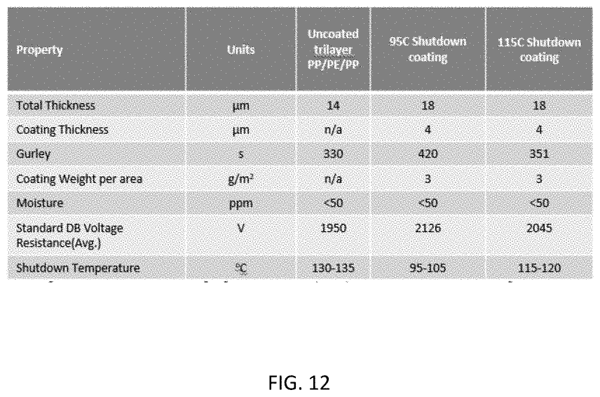

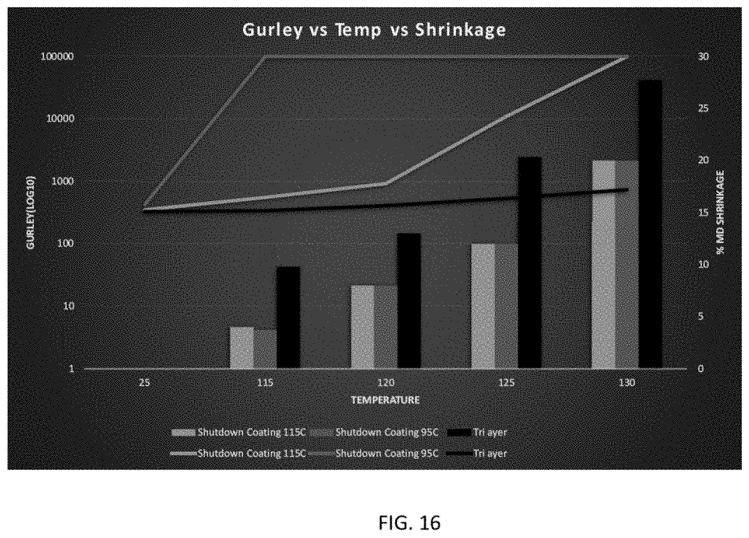

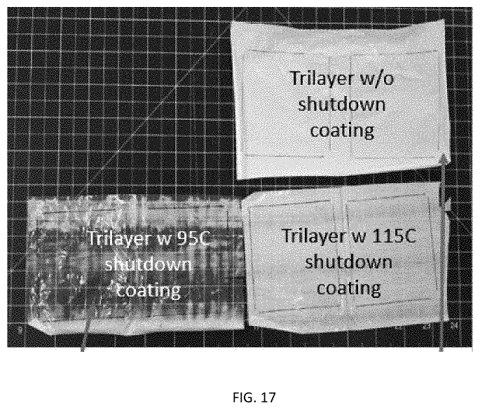

A trilayer product (PP/PE/PP) was coated with a 95° C. shutdown coating. A comparison of the properties of uncoated trilayer product and the trilayer product with a 95° C. shutdown coating is found in FIG. 12. A graph showing MD shrinkage and Gurley at 115° C., 120° C., 125° C., and 130° C. is in FIG. 16. Basefilm w/o shutdown coating has high shrinkage but has no shutdown at 125C. Basefilm with shutdown coating has pore blockage while shrinkage remains low (<15%). FIG. 17 shows the resulting film after baking at 115° C. for 2 minutes. Coated film begins to turn clear indicating pore blockage at 115C with shutdown coating. Basefilm shows signs of shrinkage but no pore blockage(remains opaque).

### Example 8

A trilayer product (PP/PE/PP) was coated with a 115° C. shutdown coating. A comparison of the properties of the uncoated trilayer product and the trilayer product with a 115° C. shutdown coating is found in FIG. 12. A graph showing MD shrinkage and Gurley at 115° C., 120° C., 125° C., and 130° C. is in FIG. 16. Basefilm w/o shutdown coating has high shrinkage but has no shutdown at 125C. Basefilm with shutdown coating has pore blockage while shrinkage remains low (<15%). FIG. 17 shows the resulting film after baking at 115° C. for 2 minutes. Coated film begins to turn clear indicating pore blockage at 115C with shutdown coating. Basefilm shows signs of shrinkage but no pore blockage(remains opaque).

### Example 9

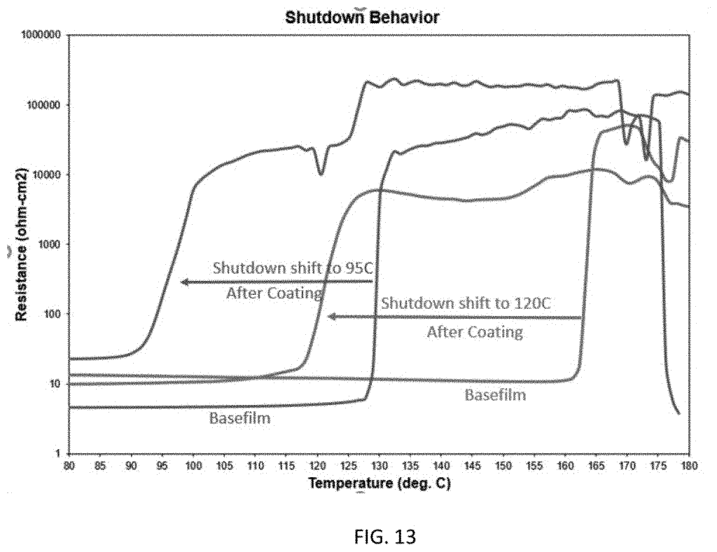

A basefilm having a shutdown at about 160° C. when uncoated is coated with a 120° C. shutdown coating, which shifts the shutdown to about 120° C. This is shown in FIG. 13. This shows that shutdown coating can be applied to desired basefilm and the desired shutdown shift can be achieved.

### Example 10

A basefilm having a shutdown of about 130° C. when uncoated is coated with a 95° C. shutdown coating. This shifts the shutdown of the basefilm to about 95° C. This is shown in FIG. 13. This shows that shutdown coating can be applied to desired basefilm and the desired shutdown shift can be achieved.

### Example 11

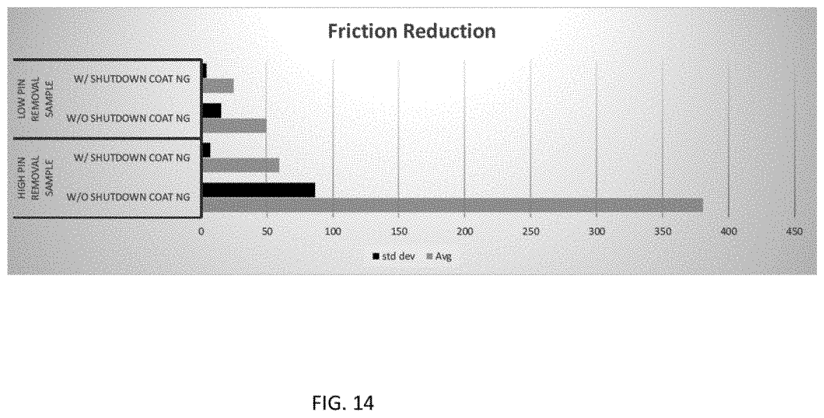

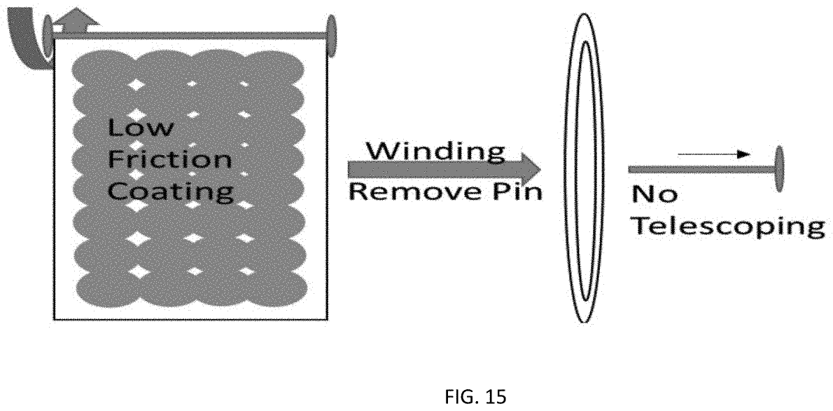

A basefilm with high pin removal was coated with a shutdown coating. FIG. 14 shows that the shutdown coating reduced pin removal force. FIG. 15 demonstrates a good result of a pin removal test, i.e., no telescoping of the film when the pin is removed. Use of a coating to lower pin removal eliminates the need to add additives to the base film, which may affect processability.

### Example 12

A basefilm with low pin removal force was coated with a shutdown coating. FIG. 14 shows that the shutdown coating reduced pin removal force. FIG. 15 demonstrates a good result of a pin removal test, i.e., no telescoping of the film when the pin is removed. Use of a coating to lower pin removal eliminates the need to add additives to the base film, which may affect processability.

### Example 13

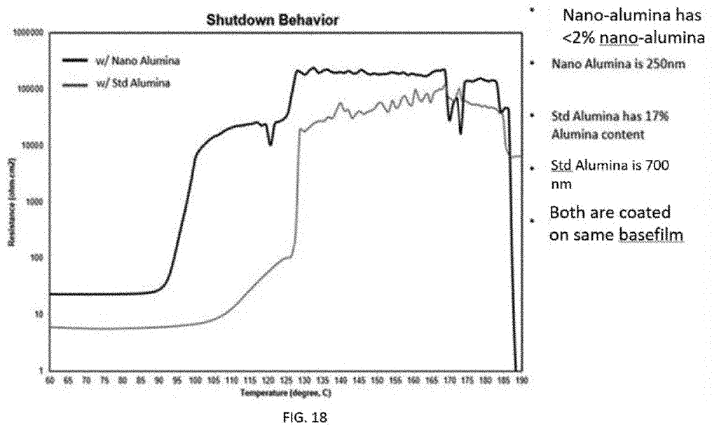

Two identical base films were coated with two different water-based shutdown coatings. One coating included polyethylene, a binder, and standard alumina with a size of about 0.7 microns (700 nm). The other coating included polyethylene, a binder, and nano-alumina with a size of 250nm. As shown in FIG. 18 herein, the shutdown coating with the nano-alumina shutdown at a much lower temperature (about 100° C. compared to about 125° C.) and the shutdown window extended to about 190° C. Thus, the shutdown separator with nano-alumina would be considered much safer than the shutdown separator with the standard alumina.

1. A coated separator comprising a microporous film and a coating on at least one side of the microporous film, wherein the coated separator shuts down at a temperature less than 140° C. or less than 135° C., wherein the coating is a water-based or solvent-based coating.

2. (canceled)

3. The coated separator of claim 1, wherein the coated separator shuts down at a temperature less than 130° C., less than 125° C. less than 120° C., or less than 115° C.

4. (canceled)

5. (canceled)

6. (canceled)

7. The coated separator of claim 1, wherein the coated separator shuts down at a temperature less than 110° C. or less than 100° C.

8. The coated separator of claim 1, wherein the microporous film itself (uncoated) does not shutdown at a temperature less than 140° C., does not shut down or shuts down at a temperature between 140° C. and 350° C., does not shutdown at a temperature less than 135° C., or does not shut down or shuts down at a temperature between 135° C. and 350° C.

9. (canceled)

10. (canceled)

11. (canceled)

12. The coated separator of claim 1, wherein:
the microporous film comprises, consists of, or consists essentially of a polyolefin;
the microporous film comprises, consists of, or consists essentially of a polyolefin, and the polyolefin is polypropylene or another polyolefin having a melt temperature at or above 160° C.; or
the microporous film is a monolayer film that comprises, consists of, or consists essentially of a polyolefin, and the polyolefin is polypropylene or another polyolefin having a melt temperature at or above 160° C.

13. (canceled)

14. (canceled)

15. The coated separator of claim 11, wherein the microporous film does not shut down or shuts down at a temperature between 160° C. and 350° C., or does not shut down or shuts down at a temperature between 135° C. and 160° C.

16. (canceled)

17. The coated separator of claim 1, wherein the coating comprises, consists of, or consists essentially of polyethylene and a binder.

18. The coated separator of claim 17, wherein the coating further comprises, consists of, or consists essentially of inorganic fine particles in an amount of 10% or less or 5% or less of the total solids in the coating.

19. (canceled)

20. The coated separator of claim 18, wherein the inorganic fine particles comprise a metal oxide having a particle size D50 of about 500 nm or less, or 250 nm or less, or 200 nm or less.

21. (canceled)

22. The coated separator of claim 18, wherein:
the metal oxide comprises, consists of, or consists essentially of alumina; or
the metal oxide comprises, consists of, or consists essentially of alumina and the microporous film has an average porosity greater than 30%.

23. The coated separator according to claim 1, wherein:
the microporous film is a monolayer microporous film;
the microporous film is a monolayer microporous film that has an average porosity greater than 30%;
the microporous film is a monolayer microporous film that comprises, consists of, or consists essentially of polypropylene; or
the microporous film is a monolayer microporous film that has an average porosity greater than 30%, and has an average porosity greater than 30%.

24. (canceled)

25. (canceled)

26. The coated separator of claim 1, wherein the average pore size of the microporous film is greater than 0.03 microns, greater than 0.04 microns, or greater than 0.045 microns.

27. (canceled)

28. (canceled)

29. The coated separator according to claim 1, wherein the microporous film is a bilayer, trilayer, or multilayer microporous film.

30. (canceled)

31. A coated separator comprising a microporous film and a coating, wherein the coating causes the separator to shutdown at a temperature lower than the temperature at which the microporous film would shrink more than 15% without any coating.

32. The coated separator of claim 31, wherein the coating causes the separator to shutdown at a temperature lower than the temperature at which the microporous film would shrink more than 12%, more than 10%, or more than 5% without any coating.

33. (canceled)

34. (canceled)

35. The coated separator of claim 31, wherein the separator shuts down at less than 140° C. or less than 135° C.

36. (canceled)

37. The coated separator of claim 35, wherein the separator shuts down at a temperature less than 130° C., less than 125° C., less than 120° C., or less than 100° C.

38. (canceled)

39. (canceled)

40. (canceled)

41. The coated separator of claim 31, wherein the microporous film itself (uncoated) does not shutdown at a temperature less than 140° C., does not shutdown or shuts down at a temperature between 140° C. and 350° C., does not shutdown at a temperature less than 135° C., or does not shutdown or shuts down at a temperature between 135° C. and 350° C.

42. (canceled)

43. (canceled)

44. (canceled)

45. The coated separator of claim 31, wherein:
the microporous film comprises, consists of, or consists essentially of a polyolefin;
the microporous film comprises, consists of, or consists essentially of a polyolefin, and the polyolefin is polypropylene or another polyolefin having a melt temperature at or above 160° C.; or
the microporous film is a monolayer film that comprises, consists of, or consists essentially of a polyolefin, and the polyolefin is polypropylene or another polyolefin having a melt temperature at or above 160° C.

46. (canceled)

47. (canceled)

48. The coated separator of claim 41, wherein the microporous film does not shut down or shuts down at a temperature between 160° C. and 350° C., or the microporous film does not shut down or shuts down at a temperature between 135° C. and 160° C.

49. (canceled)

50. The coated separator of claim 31, wherein the coating comprises, consists of, or consists essentially of polyethylene and a binder.

51. The coated separator of claim 50, wherein the coating further comprises, consists of, or consists essentially of inorganic fine particles in an amount of 10% or less or 5% or less of the total solids in the coating.

52. (canceled)

53. The coated separator of claim 51, wherein the inorganic fine particles comprise a metal oxide having a particle size D50 of about 500 nm or less, about 250 nm or less, or 200 nm or less.

54. (canceled)

55. The coated separator of claim 51, wherein the metal oxide comprises, consists of, or consists essentially of alumina.

56. The coated separator according to claim 31, wherein:
the microporous film is a monolayer microporous film;
the microporous film is a monolayer microporous film comprising, consisting of, or consisting essentially of polypropylene;
the microporous film is a monolayer microporous film having an average porosity greater than 30%; or
the microporous film is a monolayer microporous film comprising, consisting of, or consisting essentially of polypropylene that has an average porosity greater than 30%.

57. (canceled)

58. (canceled)

59. The coated separator of claim 31, wherein the average pore size of the microporous film is greater than 0.03 microns, greater than 0.04 microns, or greater than 0.045 microns.

60. (canceled)

61. (canceled)

62. The coated separator according to claim 31, wherein the microporous film is a bilayer, trilayer, or multilayer microporous film.

63. (canceled)

64. A coated separator according to claim 1, wherein the coated separator has lower pin removal force than the microporous film when the microporous film is uncoated.

65. A coated membrane for a coated separator comprising a microporous film and a coating on at least one side of the microporous film, wherein the coating of the coated membrane shuts down at a temperature less than 140° C.

66. A coated membrane comprising a microporous polyolefin film and a porous coating on at least one side of the microporous film, wherein the coating has or includes material that melts or flows and blocks the pores of the porous coating at a temperature less than 140° C.

67. A coated membrane comprising a microporous polyolefin film and a microporous coating on at least one side of the microporous film, wherein the coating has or includes polymer material that melts or flows and blocks the pores of the coating at a temperature less than 140° C.

68. A separator with a shutdown coating, wherein the coating is a water-based or solvent-based coating.

69. (canceled)

70. (canceled)

71. The separator of claim 68, wherein the coating comprises inorganic fine particles having a particle size D50 of 500 nm or less, 250 nm or less, or 200 nm or less.

72. (canceled)

73. (canceled)
